(19) United States
(12) Patent Application Publication
(10) Pub. No.: US 2025/0266204 A1
(43) Pub. Date: Aug. 21, 2025

(54) ELECTRICAL COMPONENT

(71) Applicant: Delta Electronics (Thailand) Public Co., Ltd., Samutprakarn (TH)

(72) Inventors: Hugues NJIENDE, Soest (DE); Shangeeth Kumar SHANMUGHAM, Soest (DE)

(21) Appl. No.: 19/059,304

(22) Filed: Feb. 21, 2025

(30) Foreign Application Priority Data
Feb. 21, 2024 (EP) 24158927.4
Nov. 29, 2024 (EP) 24216656.9

(51) Int. Cl. H01F 27/26; H01F 3/14; H01F 27/02; H01F 27/08; H01F 27/28; H01F 27/30

(52) U.S. Cl. CPC H01F 27/263; H01F 3/14; H01F 27/02; H01F 27/08; H01F 27/2823; H01F 27/306

(57) ABSTRACT

An electrical component includes at least one soft-magnetic core element and at least one packaged electromagnetic coil assembly, with each packaged electromagnetic coil assembly includes (i) a thermally conductive and electrically insulating holder with at least one soft-magnetic element, wherein the at least one soft-magnetic element is within the convex hull of the holder and held by the holder, (ii) a coil formed of enamelled wire and having a magnetic axis and two ends, wherein the coil, the holder and the at least one soft-magnetic element forming a coil assembly, wherein the holder and the coil are such that the magnetic axis of the coil passes through at least one air gap provided by the holder, and (iii) a thermally conductive and electrically insulating cover, which cover includes an inner side facing an interior space surrounded by the cover and an outer side facing an exterior space.

### CROSS-REFERENCE TO RELATED APPLICATIONS

This application claims priority to EP patent application Ser. No. 24/158,927.4, filed on Feb. 21, 2024, and EP patent application Ser. No. 24/216,656.9, filed on Nov. 29, 2024. The disclosures of the aforementioned applications are hereby incorporated by reference in their entireties.

### TECHNICAL FIELD

The application relates to an electrical component and to a method for manufacturing the electrical component.

### BACKGROUND

Electromagnetic coils are fundamental building blocks of chokes, also known as inductors, and transformers.

A changing, in particular alternating, current flowing through a coil of a choke, for example, creates a changing, in particular alternating, magnetic field, which changing magnetic field in turn induces an electromotive force in the coil of the choke, the induced electromotive force opposing a change in the current. A changing, in particular alternating, current flowing through a primary coil of a transformer, for example, creates a changing, in particular alternating, magnetic field, and the changing magnetic field, when passing through a coupled secondary coil, induces an electromotive force in the secondary coil.

Electromagnetic coils used as part of chokes or transformers in the state of the art are often wound on ferromagnetic or ferrimagnetic cores to increase the magnetic field due to the strong possible magnetisation produced by ferromagnetic or ferrimagnetic materials. Preferably, the electromagnetic coils are wound on ferromagnetic or ferrimagnetic cores providing a magnetic circuit of one or more closed loop paths. Both ferromagnetic and ferrimagnetic materials typically experience saturation behaviour when magnetic fields above a certain strength are applied to them. Saturation behaviour appears in the form of a saturation magnetisation in ferromagnetic or ferrimagnetic materials.

Once saturation is reached, inductors or transformers show unwanted nonlinear behaviour. To enable ferromagnetic or ferrimagnetic cores to cope with high magnetic field strengths without saturating, the use of air gaps is known in the prior art.

Chokes, for example, are often designed with an air gap in a magnetic path where the centre legs of two ferrimagnetic core elements, for example embodied as so called ‘E’ shaped cores, meet. By changing the dimensions of such an air gap, the inductance of the choke can be controlled, and the magnetic field strength at which saturation occurs may be suitably shifted. Air gaps in ferromagnetic core elements typically need to be manufactured to great precision, often by grinding. While common cores may be readily available, non-standard air gap distributions and core geometries typically lead to a cumbersome manufacturing process of ferromagnetic cores with air gaps. To reduce eddy currents, it may further be preferential to provide a plurality of smaller air gaps instead of fewer larger gaps, which may further complicate the manufacturing process.

For frequencies commonly encountered in switched-mode power supplies, such frequencies often being in the range of 10 to 200 kHz, the Skin effect may become prominent for example in conductors of chokes, which chokes are for example part of an active power factor correction for a switched-mode power supply. To reduce the Skin effect and the proximity effects between nearby parallel conductors of such a choke, for example, electromagnetic coils as known in the prior art are often wound around ferrites which are ferrimagnetic materials with low electrical conductivity, wherein as wire Litz wire is used, often triple-insulated Litz wire; as winding pattern, basket winding is often employed and the wound wire, in particular Litz wire, forms multiple layers around the ferrite core. Litz wire, and in particular triple-insulated Litz wire, does not lend itself to a full production automation of chokes or transformers, however. The multiple layers of Litz wire as used in the prior art further typically lead to a large temperature gradient between the outermost layer and the innermost layer of the winding around the ferrite core, thereby potentially altering behaviour of the choke or transformer due to heating of the ferrite core.

Instead of using Litz wire wound in multiple layers around a ferrite core, in the prior art edgewise-wound coils are used as well; edgewise-wound coils are in particular suitable for applications in power electronics, for example for use with switched-mode power supplies for charging solutions for vehicles. Edgewise-wound coils typically only comprise enamelled wire without further insulation. To insulate a choke comprising an edgewise-wound coil around a ferrite core, in the prior art the entire choke is potted into an electrically insulating cover, for example: such an insulation solution is detrimental for cooling, however, as both the coil and the ferrite core are encapsulated by the insulating cover and the potting material.

Prior art document JP2009246221A discloses a choke built up as follows: in a holding portion of the choke, soft-magnetic inner core pieces are held that are distanced from each other through gap defining portions; around the holding portion, a coil is wound; the holding portion and the coil wound thereon are contained between two frame-shaped members that are arranged on opposite sides of the holding portion with respect to a magnetic axis of the coil; a respective soft-magnetic outer core piece is arranged at each frame-shaped member on the side of the respective frame-shaped member facing away from the holding portion and the coil; the entire assembly as just described is coated in a resin for electrical insulation. As the entire assembly of the choke of JP2009246221A is resin-coated and potentially further enclosed in a casing, the choke of JP2009246221A is difficult to cool. The choke of JP2009246221A is such that when put into a cavity of a chassis, clearance and creepage distances are disadvantageously short, thereby leading to potential insulation problems.

Prior art document CN209515404U discloses a multi-air-gap large current choke. The choke of CN209515404U comprises two PQ cores, a flat coil with two ends, R-rod cores, insulating gaskets, a sleeve, a base, a shell, a bottom shell and two annular gaskets. The R-rod cores are arranged coaxially and are arranged between the middle columns of the two PQ cores. The insulating gaskets may be positioned between the middle column of each PQ core and the neighbouring R-rod core to form air gaps, for example, or between neighbouring R-rod cores. The sleeve is positioned between the coil 3 and the middle columns of the PQ cores: the R-rod cores and the insulating gaskets are positioned in the sleeve and the coil is directly wound on the sleeve. The annular gaskets are provided on the upper and lower surface of the coil to avoid contact between the coil and the PQ cores. CN209515404U does not disclose any potting or further protection of the coil from access, i.e. the coil of the choke of CN209515404U is accessible from outside, potentially causing problems with respect to electrical insulation. The choke of CN209515404U is such that when put into a cavity of a chassis, clearance and creepage distances are disadvantageously short, thereby leading to potential insulation problems.

Prior art document CN218100935U discloses a choke that comprises two PQ cores, two insulating sheets, a coil, a base and a barrel in which magnetic sheet(s) are positioned. The barrel comprises grooves into which the magnetic sheet(s) may be arranged. By suitably positioning magnetic sheets in different grooves, air gaps of various dimensions and numbers may be obtained. The coil is positioned outside the barrel. CN218100935U does not disclose any potting or further protection of the coil from access, i.e. the coil of the choke of CN218100935U is accessible from outside, potentially causing problems with respect to electrical insulation. The choke of CN218100935U is such that when put into a cavity of a chassis, clearance and creepage distances are disadvantageously short, thereby leading to potential insulation problems.

### SUMMARY

It is the object of the application to create an electrical component pertaining to the technical field initially mentioned that mitigates at least some of the disadvantages of solutions as known in the prior art.

The solution of the application is specified by the features of claim 1. The application relates to an electrical component, in particular for a switched-mode power supply, comprising (i) at least one soft-magnetic core element and (ii) at least one packaged electromagnetic coil assembly, with each packaged electromagnetic coil assembly of the at least one packaged electromagnetic coil assembly comprising 1) at least one soft-magnetic element, 2) a thermally conductive and electrically insulating holder, wherein the at least one soft-magnetic element is within the convex hull of the holder and held by the holder, and wherein the holder is made of a first diamagnetic material or a first paramagnetic material, 3) a coil formed of enamelled wire and having a magnetic axis and two ends, wherein the wire of the coil is wound around the holder with the at least one soft-magnetic element, with the coil, the holder and the at least one soft-magnetic element forming a coil assembly, wherein the holder and the coil are such that the magnetic axis of the coil passes through at least one air gap provided by the holder, and 4) a thermally conductive and electrically insulating cover, which cover comprises an inner side facing an interior space surrounded by the cover and an outer side facing an exterior space, which interior space is only accessible through one opening in the cover and the coil assembly being arranged in the interior space, wherein the cover and the coil assembly are such that only the two ends of the wire of the coil protrude through the opening, wherein the cover is made of a second diamagnetic material or a second paramagnetic material, and wherein the packaged electromagnetic coil assembly comprises a thermally conductive and electrically insulating potting material, with the coil assembly being potted in the interior space surrounded by the cover with the potting material. Each soft-magnetic core element of the at least one soft-magnetic core element is in direct contact with at least a part of the outer side of the cover of one or more of the at least one packaged electromagnetic coil assembly. Each soft-magnetic core element of the at least one soft-magnetic core element is at most in contact with the potting material of the at least one packaged electromagnetic coil assembly at surfaces of the respective soft-magnetic core element facing the outer side of the cover of the one or more of the at least one packaged electromagnetic coil assembly with which the respective soft-magnetic core element is in direct contact.

The at least one packaged electromagnetic coil assembly is combined with soft-magnetic core elements to provide an electrical component, for example a choke or a transformer. Soft-magnetic materials are materials that can be easily magnetised by an external magnetic field, the magnetisation in soft-magnetic materials producing a much stronger magnetic flux density in the soft-magnetic material than the magnetic flux density of the external magnetic field in air. Compared to hard-magnetic materials, soft-magnetic materials have small hysteresis losses. As soft-magnetic materials for such soft-magnetic core elements, for example ferrites or other materials with high magnetic permeability may be used. Cores known in the prior art as ferrite cores, amorphous cores, nanocrystalline cores or pressed-powder cores are for example suitable. Similarly, the at least one soft-magnetic element held by the holder may be provided as at least one ferrite element, or as at least one amorphous element, or at least one nanocrystalline element, or at least one pressed-power element, or suitable combinations thereof, for example. In an implementation, for both soft-magnetic core elements and the at least one soft-magnetic element, materials are chosen with (i) low electrical conductivity to minimise eddy currents and (ii) good thermal conductivity to facilitate cooling. As materials, in an implementation, soft-magnetic ferrites may be used. Different soft-magnetic materials may be used for the soft-magnetic core elements and the at least one soft-magnetic element.

The holder of each packaged electromagnetic coil assembly of the inventive electrical component in which at least one soft-magnetic element is arranged is thermally conductive in order to facilitate cooling of the at least one soft-magnetic element. The holder is further electrically insulating to prevent a shorting between turns of the coil wound around the holder. The holder is furthermore diamagnetic or paramagnetic, i.e. it only interacts weakly with a magnetic field that may be created by the coil that is wound around the holder. The holder may be made from a plastic material and may be formed by a moulding process. The holder may also be made from a ceramic material. The holder is designed in such a way that it may hold the at least one soft-magnetic element. In case the at least one soft-magnetic element is embodied as at least one ferrite element, for example, as ferrite material manganese-zinc ferrite or nickel-zinc ferrite may be used, for example. The at least one soft-magnetic element may in turn be provided in a standard size, for example in the form of soft-magnetic, in particular ferrite, pills. The holder may be designed in such a way that it comprises reception slots into which the at least one soft-magnetic element may be inserted. By suitably designing number and spatial arrangement of such reception slots in the holder, a desired distribution of air gaps in the holder between neighbouring soft-magnetic elements in a magnetic path may be obtained. The holder may thus advantageously provide air gaps of a precise spatial extent and position as required for a specific application, without needing to grind air gaps into winding legs as typically required in the prior art. Furthermore, for manufacture of the inventive electrical component, the at least one soft-magnetic element, in particular embodied as ferrite pills, may advantageously be simply inserted into reception slots of the holder(s). A holder made of plastic material may advantageously provide a large design freedom with precise manufacturing tolerances.

The coil formed of enamelled wire around the holder creates a magnetic field when a current flows through it. Enamelled wire is wire, in particular made of copper or aluminium, to which wire enamels are applied for electrical insulation. As wire enamels, for example, polyurethane wire enamels, solderable polyesterimide wire enamels, THEIC-modified polyester wire enamels, THEIC-polyesterimide wire enamels, polyamide-imide wire enamels, or polyvinylformal wire enamels may be used. In an implementation, at the two ends of the enamelled wire, insulation is fully removed. Enamelled wire may also be termed coated wire.

In an implementation, the coil is formed as an edgewise-wound coil formed of enamelled flat wire as edgewise-wound coils advantageously may enable a simplified manufacture of the inventive electrical component.

The magnetic axis of the coil may be defined as line of symmetry of the magnetic field pattern created by the coil when a current flows through it. For a coil embodied in the form of a solenoid, for example, the magnetic axis may be coincident with an axis passing through a geometric centre of the solenoid. For symmetric coils, the magnetic axis of the coil may correspond to an axis of symmetry of the coil. The magnetic axis may be provided with a direction, e.g. a main direction of the magnetic field in the interior of the coil when a current flows through the coil. The magnetic axis need not be provided with a sense of direction, however.

A convex hull of a shape may be defined as the smallest convex set that contains it. As the at least one soft-magnetic element is within the convex hull of the holder, the coil wound around the holder advantageously does not come into direct contact with the at least one soft-magnetic element and may advantageously have a defined geometric relationship, in particular distance, to the at least one soft-magnetic element by a suitable design of the holder. The holder thus electrically insulates the coil from the at least one soft-magnetic element. The coil may therefore be tightly wound around the holder, which advantageously may improve mechanical stability and cooling of the at least one packaged electromagnetic coil assembly of the electrical component.

As the coil is made of an enamelled wire, for further electrical insulation each packaged electromagnetic coil assembly of the inventive electrical component comprises a thermally conductive and electrically insulating cover. Each cover is embodied such that an interior space surrounded by the respective cover and an exterior space may be distinguished, the interior space being faced by an inner side of the cover and the exterior space being faced by an outer side of the cover. Each cover does not fully surround the respective interior space; instead, an opening is provided in each cover through which the respective interior space and the exterior space are connected. When manufacturing the inventive electrical component, the coil assembly of each packaged electromagnetic coil assembly is moved through the respective opening into the interior space where it is potted with a thermally conductive and electrically insulating potting material. In an implementation, each cover is embodied as a one-piece cover, i.e. the cover may not need to be assembled from sub-components but may be directly formed, for example in a moulding process as a cover made of a plastic material. The cover may also be made from a ceramic material. The coil assembly of each packaged electromagnetic coil assembly is therefore electrically insulated by both the respective cover and the potting material. Besides the opening in the cover through which the coil assembly and the potting material is inserted into the interior space, the cover does not comprise further openings to prevent the inserted potting material from leaking before it may sufficiently harden.

In an implementation, the cover may be embodied such that it is shaped in a substantially cup-like manner. Accordingly, the cover may comprise a portion that may be identified as a bottom portion and a lateral portion extending away from the bottom portion, the bottom portion and the lateral portion together surrounding an interior space in which the coil assembly and the potting material may be received; the opening may be positioned opposite the bottom portion. In an implementation, the cover and its opening are shaped in such a way that the coil assembly may be directly placed in the interior space by moving it through the opening, thereby advantageously simplifying manufacture of the electrical component. The cover and its opening are therefore adapted to the coil assembly that is placed in the interior space surrounded by the cover.

In an implementation, the cover is shaped in such a way that the shape and the volume of the interior space surrounded by the cover is matched to the shape and volume of the coil assembly. This way, all parts of the coil assembly that face the inner side of the cover are advantageously close to the inner side of the cover, thereby improving cooling of the coil, with the potting material fixing the coil assembly in the interior space. To improve electrical insulation of the electrical component, in an implementation, the parts of the coil assembly facing the opening and thereby accessible from the exterior space are embedded in the potting material. The cover and the coil assembly of each packaged electromagnetic coil assembly are designed such that only the two ends of the wire of the coil protrude through the opening into the exterior space. In an implementation, the cover and the coil assembly may be designed such that parts of the holder above which the coil is not present are in direct contact with or in close vicinity to the cover, i.e. the cover may be designed to tightly enclose certain parts of the coil assembly placed into the interior space surrounded by the cover.

The convex hull of the cover may substantially be shaped as the surface of a cuboid, with one surface of the cuboid missing, through which opening the coil assembly may be inserted into the cover. After the coil assembly and the potting material is inserted into the cover through the opening, the opening may be sealed by a baseplate with slots through which the two ends of the coil may be guided, i.e. the baseplate and the cover may fully surround the interior space. In general, the surface of the cover may deviate from the shape of the surface of a cuboid and may in particular be adapted to the shape of the coil assembly.

The potting material may be inserted into the interior space surrounded by the cover prior to the inserting of the coil assembly, and after a displacement of the potting material in the wake of the insertion, the potting material may surround the coil assembly from all sides facing the inner side of the cover as well as the opening. Alternatively, the coil assembly may also be first inserted into the interior space surrounded by the cover and the potting material may only thereafter be inserted into the interior space in which the coil assembly is already present. In an implementation, a potting material is chosen which only interacts weakly with the magnetic field created by the coil. As potting material, thermosetting plastics, silicone rubber gels or epoxy resins may be used, for example, with filling material to improve thermal conductivity. As potting material, a polyurethane resin may be used, for example.

The cover is further diamagnetic or paramagnetic, i.e. it only interacts weakly with a magnetic field that may be created by the coil that is wound around the holder. The cover may be made from a plastic material and may be formed by a moulding process. The cover may also be made from a ceramic material. The plastic material or the ceramic material of the cover may be different from or equal to the plastic material or the ceramic material of the holder. The cover may thus easily be adapted to a specific shape of the coil.

The magnetic axis of the coil wound around the holder passes through at least one air gap, which as described above is provided by the arrangement of the at least one soft-magnetic element in the convex hull of the holder. In an implementation, the holder and the at least one soft-magnetic element are such that at an intersection of the at least one soft-magnetic element and the magnetic axis, the magnetic axis is orthogonal to the at least one soft-magnetic element.

Each soft-magnetic core element of the at least one soft-magnetic core element is arranged in the exterior space(s) of the at least one packaged electromagnetic coil assembly, i.e. the soft-magnetic core elements are arranged such that they are in direct contact, that is immediately touch, at least a part of the outer side of the cover of one or more of the at least one packaged electromagnetic coil assembly. Each soft-magnetic core element of the at least one soft-magnetic core element is at most in contact with the potting material of the at least one packaged electromagnetic coil assembly at surfaces of the respective soft-magnetic core element facing the outer side of the cover of the one or more of the at least one packaged electromagnetic coil assembly with which the respective soft-magnetic core element is in direct contact. Specifically, when potting a coil assembly into a corresponding cover, some of the potting material may flow out from the cover. This potting material which has flown out may then be in contact with surfaces of at least one soft-magnetic core element that face the respective packaged electromagnetic coil assembly from which potting material has flown out. In an implementation, the soft-magnetic core element(s) is/are positioned such around the at least one packaged electromagnetic coil assembly that closed loop path(s) around the at least one packaged electromagnetic coil assembly is/are provided. Through the at least partial direct contact between the soft-magnetic core element(s) and the cover(s), the at least one packaged electromagnetic coil assembly may advantageously be cooled through the soft-magnetic core element(s). The soft-magnetic core element(s) therefore at most come into direct contact with the potting material that is comprised by the at least one packaged electromagnetic coil assembly at surfaces of the soft-magnetic core element(s) facing the at least one packaged electromagnetic coil assembly; substantially, the soft-magnetic core element(s) are separated from said potting material through the cover(s) of the at least one packaged electromagnetic coil assembly. In some embodiments, the at least one soft magnetic core element may not be in contact with the potting material of the at least one packaged electromagnetic coil assembly.

To improve cooling, in an implementation, the outer side(s) of the packaged electromagnetic coil assembly/assemblies is/are formed such that an extensive contact between the soft-magnetic core element(s) and the packaged electromagnetic coil assembly/assemblies is possible.

As each packaged electromagnetic coil assembly is electrically insulated through the respective cover and potting material, the soft-magnetic core element(s) do not need to be potted in an electrically insulating potting material. In case the entire electrical component is to be potted into a chassis of an on-board charger for a vehicle, for example, a potting material for potting the electrical component may be used that is primarily optimised for high thermal conductivity, i.e. a different potting material may be used for potting the entire electrical component as compared to the potting material used in the at least one packaged electromagnetic coil assembly. Advantageously, the inventive electrical component has improved clearance and creepage distances when placed into a cavity of a chassis as the coil of each packaged electromagnetic coil assembly is shielded at least by the respective cover and the potting material. The inventive electrical component therefore provides a high degree of electrical insulation.

The inventive electrical component is therefore advantageously both simple to manufacture and may be cooled in an improved manner as only those parts of the electrical component that mostly require reinforced electrical insulation, i.e. the coil(s), are potted in an electrically insulating potting material-in contrast to solutions as known in the prior art, for purposes of electrical insulation it is therefore advantageously not required to pot and cover the entire electrical component.

In an embodiment of the electrical component according to the application, the coil of at least one of the at least one packaged electromagnetic coil assembly is an edgewise-wound coil.

In a further embodiment of the electrical component according to the application, for at least one of the at least one packaged electromagnetic coil assembly, the coil assembly and the potting material together fill up the interior space surrounded by the cover, and/or for at least one of the at least one packaged electromagnetic coil assembly, the coil assembly and the cover are embodied such that a shape and volume of the interior space is substantially matched to a shape and volume of the coil assembly, and/or for at least one of the at least one packaged electromagnetic coil assembly, the cover is shaped in a substantially cup-like manner, with the substantially cup-like cover being such that both the coil assembly and the potting material are inserted through the opening into the interior space surrounded by the cover, and/or for at least one of the at least one packaged electromagnetic coil assembly, the cover is embodied as a one-piece cover.

In a further embodiment of the electrical component according to the application, the holder comprises at least two reception slots, with a soft-magnetic element being inserted into each of the at least two reception slots, and the at least two reception slots and the shape of the at least two inserted soft-magnetic elements are such that an air gap is present between any two inserted soft-magnetic elements.

In a further embodiment of the electrical component according to the application, the electrical component further comprises a baseplate with slots, wherein the ends of the coil of each of the at least one packaged electromagnetic coil assembly are guided through the slots, and wherein the baseplate is embodied and positioned such at the opening of each of the at least one packaged electromagnetic coil assembly that it prevents access to the interior space of the respective packaged electromagnetic coil assembly from the exterior space of the respective packaged electromagnetic coil assembly.

In a further embodiment of the electrical component according to the application, the electrical component is embodied as a choke.

Together with the at least one packaged electromagnetic coil assembly or already on its own, the at least one soft-magnetic core element, for example embodied as manganese-zinc ferrite core element or nickel-zinc ferrite core element, may provide a closed loop path of a magnetic circuit. In an implementation, the at least one soft-magnetic core element may comprise no winding leg around which a coil is wound, with coils of the choke only being provided in the at least one packaged electromagnetic coil assembly. In an implementation, the at least one soft-magnetic core element is designed in such a way that it is in extensive direct contact with the outer sides of the covers of the at least one packaged electromagnetic coil assembly. As the at least one soft-magnetic core element in the choke does not need to be packaged for the sake of electrical insulation as required in the prior art, it can be in direct contact with a chassis of an on-board charger, for example, and thereby advantageously be cooled in an improved manner.

In a further embodiment of the electrical component according to the application, the electrical component is embodied as a transformer.

Besides chokes, transformers may also be constructed using at least two packaged electromagnetic coil assemblies and at least one soft-magnetic core element, wherein each soft-magnetic core element of the at least one soft-magnetic core element is in direct contact with at least a part of the outer side of the cover of one or more of the at least two packaged electromagnetic coil assemblies. For constructing transformers, in an implementation, packaged electromagnetic coil assemblies and soft-magnetic core elements are placed in such a way that a strong coupling is provided between the coils of the at least two electromagnetic coil assemblies.

A packaged electromagnetic coil assembly of the electrical component may also be such that it comprises a further coil. The further coil may be formed of enamelled wire. The further coil may also be wound around the holder with the at least soft-magnetic element of the packaged electromagnetic coil assembly. A magnetic axis of the further coil may coincide with a magnetic axis of the coil. The further coil may also have two ends. In such a packaged electromagnetic coil assembly, four ends of the coil and the further coil may therefore protrude through the opening. The further coil may also be surrounded by the potting material. An electrical component comprising such a packaged electromagnetic coil assembly may be used for constructing a transformer: this way, only one such packaged electromagnetic coil assembly and at least one soft-magnetic core element may be needed for constructing a transformer.

A choke may be used as a power factor correction choke for a switched-mode power supply, for example. Switched-mode power supplies typically comprise non-linear elements such as rectifiers that distort current. To counter such distortion, active power correction may be used, which active power correction often operates at frequencies between 10 to 200 kHz. A choke may also be used as part of a boost converter. The electrical component may be used in applications in which voltages between 200 and 800 V are present, for example.

Due to its construction, a power factor correction choke comprising at least one packaged electromagnetic coil assembly may advantageously be cooled in an improved manner, as the soft-magnetic core elements need not be covered for providing electrical insulation and may therefore be directly connected to a cooling sink, for example.

In a further embodiment of the electrical component according to the application, the electrical component embodied as choke comprises one packaged electromagnetic coil assembly and two soft-magnetic core elements, wherein the two soft-magnetic core elements are in direct contact with each other and provide a closed loop path around the packaged electromagnetic coil assembly.

The two soft-magnetic core elements may have a same shape and size. Each of the two soft-magnetic core elements may be embodied as follows: the soft-magnetic core element comprises two planes of symmetry passing through a circular section of the soft-magnetic core element, which circular section has a diameter that is smaller than a height of two outer legs of the soft-magnetic core element, the two outer legs forming flanges. Between the circular section and the two outer legs, two ‘V’ shaped sections are arranged which connect the circular section and the two outer legs. When placed around the packaged electromagnetic coil assembly, the two soft-magnetic core elements are in direct contact with each other at their respective two outer legs. The cover of the packaged electromagnetic coil assembly may comprise two recesses on opposite side with respect to the magnetic axis of the coil, the two recesses being matched in size to the circular section of the two soft-magnetic core elements. When arranging the two soft-magnetic core elements around the packaged electromagnetic coil assembly, their respective circular sections may be inserted into the corresponding recesses of the cover. After the circular sections are placed in the two recesses, the outer legs of the two soft-magnetic core elements may extend along two sides of the cover that are parallel to the magnetic axis of the coil. Accordingly, a closed loop path around the packaged electromagnetic coil assembly may be provided by the four outer legs of the two soft-magnetic core elements, the four ‘V’ shaped section of the two soft-magnetic core elements, and the two circular sections of the two soft-magnetic core elements. A closed loop path may also be provided by the packaged electromagnetic coil assembly, the two circular sections of the two soft-magnetic core elements and two outer legs of the two soft-magnetic core elements arranged on one side of the cover-similarly, another closed loop path may be provided through the two outer legs of the two soft-magnetic core elements arranged on the other side of the cover.

In a further embodiment of the electrical component according to the application, the electrical component embodied as choke comprises a) two packaged electromagnetic coil assemblies whose respective magnetic axes are distinct and parallel to each other, with the two packaged electromagnetic coil assemblies being arranged next to one another, and b) two soft-magnetic core elements, wherein the two soft-magnetic core elements are, with respect to the two parallel magnetic axes, arranged on opposite sides of the two packaged electromagnetic coil assemblies, wherein a first soft-magnetic core element of the two soft-magnetic core elements comprises a protruding soft-magnetic core section extending into a space between the two packaged electromagnetic coil assemblies, and wherein a second soft-magnetic core element of the two soft-magnetic core elements is directly connected to the protruding soft-magnetic core section.

A choke according to such an embodiment may be used for an interleaved converter, for example. The two packaged electromagnetic coil assemblies are separated from each other by the protruding soft-magnetic core section of the first soft-magnetic core element. As the path through the protruding soft-magnetic core section has smaller magnetic reluctance than a path through the packaged electromagnetic coil assembly, in this embodiment the two coils of the two packaged electromagnetic coil assemblies are only weakly coupled as most of the magnetic fields passing through any one of them will bypass the other through the protruding soft-magnetic core section. In this embodiment, the protruding soft-magnetic core section extends in a parallel manner to the two magnetic axes of the two packaged electromagnetic coil assemblies, and the second soft-magnetic core element and remaining parts of the first soft-magnetic core element are orthogonal to the two magnetic axes.

In a further embodiment of the electrical component according to the application, the electrical component embodied as choke comprises a) two packaged electromagnetic coil assemblies whose respective magnetic axes extend along a common line and b) three soft-magnetic core elements, wherein two soft-magnetic core elements of the three soft-magnetic core elements are arranged on opposite sides of the two packaged electromagnetic coil assemblies with respect to the common line, and wherein a third of the three soft-magnetic core elements is arranged between the two packaged electromagnetic coil assemblies, wherein each of the two soft-magnetic core elements is in direct contact with the third soft-magnetic core element.

In this embodiment, the two packaged electromagnetic coil assemblies are separated from each other by the third soft-magnetic core element. A first and second soft-magnetic core element of the three soft-magnetic core elements may each be shaped as described above, comprising a circular section, two ‘V’ shaped sections and two outer legs. The cover of a first packaged electromagnetic coil assembly of the two packaged electromagnetic coil assemblies may comprise a matching first recess into which the circular section of the first soft-magnetic core element is placed, and the cover of a second packaged electromagnetic coil assembly of the two packaged electromagnetic coil assemblies may comprise a matching second recess into which the circular section of the second soft-magnetic core element is placed. The respective two outer legs of the first and second soft-magnetic core element may extend along the cover of the first and second packaged electromagnetic coil assembly and indirectly contact each other via the third soft-magnetic core element. The third soft-magnetic core element may have a circular section, two ‘V’ shaped sections and two outer pillars. The sides of the covers facing each other may both comprise a recess matched to the circular section of the third soft-magnetic core element.

In a further embodiment of the electrical component according to the application, the electrical component embodied as choke comprises a) three packaged electromagnetic coil assemblies whose respective magnetic axes are distinct and parallel to each other, with the three packaged electromagnetic coil assemblies being arranged next to one another, and b) two soft-magnetic core elements, wherein the two soft-magnetic core elements are, with respect to the three parallel magnetic axes, arranged on opposite sides of the three packaged electromagnetic coil assemblies, wherein each of the two soft-magnetic core elements comprises respective protruding soft-magnetic core sections extending into a first space and a second space, with the first space being between a first and a second packaged electromagnetic coil assembly of the three packaged electromagnetic coil assemblies and with the second space being between the second and a third packaged electromagnetic coil assembly of the three packaged electromagnetic coil assemblies, and wherein the first soft-magnetic core element is directly connected to the second soft-magnetic core element via their respective protruding soft-magnetic core sections in both the first space and the second space.

In this embodiment, the first and the second packaged electromagnetic coil assembly and the second and third packaged electromagnetic coil assembly respectively are separated from each other by protruding soft-magnetic core sections of two soft-magnetic core elements. A choke according to this embodiment may be used as a three-phase power factor correction choke, for example.

In a further embodiment of the electrical component according to the application, the electrical component embodied choke comprises
a) six packaged electromagnetic coil assemblies, wherein a first, second and third packaged electromagnetic coil assembly have magnetic axes extending along a first common line and wherein a fourth, fifth and sixth packaged electromagnetic coil assembly have magnetic axes extending along a second common line, wherein the first common line and the second common line are distinct and parallel to each other, wherein the first packaged electromagnetic coil assembly is arranged next to the fourth packaged electromagnetic coil assembly, wherein the second packaged electromagnetic coil assembly is arranged next to the fifth packaged electromagnetic coil assembly, and wherein the third packaged electromagnetic coil assembly is arranged next to the sixth packaged electromagnetic coil assembly, and
b) four soft-magnetic core elements, wherein
a. a first soft-magnetic core element of the four soft-magnetic core elements is in direct contact with the first and the fourth packaged electromagnetic coil assemblies,
b. a second soft-magnetic core element of the four soft-magnetic core elements is in direct contact with (i) the second and the fifth packaged electromagnetic coil assemblies and with (ii), via a second protruding soft-magnetic core section of the second soft-magnetic core element protruding into a first space between the first and the fourth packaged electromagnetic coil assemblies, the first and the fourth packaged electromagnetic coil assemblies,
c. a third soft-magnetic core element of the four soft-magnetic core elements is in direct contact with (i) the third and the sixth packaged electromagnetic coil assemblies and with (ii), via a third protruding soft-magnetic core section of the third soft-magnetic core element protruding into a second space between the second and the fifth packaged electromagnetic coil assemblies, the second and the fifth packaged electromagnetic coil assemblies, and
d. a fourth soft-magnetic core element of the four soft-magnetic core elements is in direct contact with the third and the sixth packaged electromagnetic coil assemblies, wherein the fourth soft-magnetic core element comprises a fourth protruding soft-magnetic core section protruding into a third space between the third and the sixth electromagnetic coil assemblies.

A choke according to this embodiment may be used as a six-switch power factor correction choke, for example.

The application also relates to a method for manufacturing an electrical component according to the application, the method comprising the following steps: a) for each packaged electromagnetic coil assembly of the at least one packaged electromagnetic coil assembly, (i) providing the thermally conductive and electrically insulating holder with the at least one soft-magnetic element; (ii) Forming the coil assembly by placing the coil around the holder; (iii) inserting, through the opening in the cover, the coil assembly into the interior space surrounded by the cover and the thermally conductive and electrically insulating potting material; and b) arranging the at least one soft-magnetic core element such that it is in direct contact with at least a part of the outer side of the cover of one or more of the at least one packaged electromagnetic coil assembly and such that each soft-magnetic core element of the at least one soft-magnetic core element is at most in contact with the potting material of the at least one packaged electromagnetic coil assembly at surfaces of the respective soft-magnetic core element facing the outer side of the cover of the one or more of the at least one packaged electromagnetic coil assembly with which the respective soft-magnetic core element is in direct contact.

Advantageously, an electrical component according to the application may be produced in a simple manner, the production being fully automatable and precise.

In an embodiment of the method according to the application, for at least one of the at least one packaged electromagnetic coil assembly, the coil is embodied as an edgewise-wound coil surrounding an empty interior and the two ends of the edgewise-wound coil are directed into a same direction and are on an ending side of the coil, wherein the step of placing the coil around the holder comprises inserting the holder into the empty interior of the edgewise-wound coil and wherein in the step of inserting of the coil assembly into the interior space surrounded by the cover, the coil assembly is inserted in such a way into the interior space that the side of the coil opposite to the ending side is inserted first into the interior space and the two ends of the coil protrude out of the cover through the opening in the cover after the coil assembly is inserted into the interior space.

The ending side of the coil may correspond to the side of the coil at which a baseplate may be arranged.

In a further embodiment of the method according to the application, the method further comprises the following steps: guiding the ends of the coil of each of the at least one packaged electromagnetic coil assembly through slots of a baseplate.

In a further aspect of the application, the application relates to a vehicle, in particular a battery electric vehicle or hybrid electric vehicle, comprising an on-board charger with a chassis surrounding a cavity for receiving an electrical component according to the application, in particular embodied as a choke, wherein the electrical component is placed into the cavity, in particularly potted into the cavity with a thermally conductive chassis potting material.

The electrical component may be directly connected to the chassis, which chassis thereby may advantageously serve as a cooling sink for the soft-magnetic core elements of the electrical component. Alternatively, the electrical component may also be potted into the cavity of the chassis with a chassis potting material. The chassis potting material may be different from the potting material that may be used in the at least one packaged electromagnetic coil assembly. As chassis potting material, thermosetting plastics, silicone rubber gels or epoxy resins may be used, for example, with filling material to improve thermal conductivity.

Besides being used in vehicles, electric components according to the application may also be used in the general field of telecommunications, for example as electrical components, in particular chokes or transformers, for networks, or in other industrial and automotive applications.

Other advantageous embodiments and combinations of features come out from the detailed description below and the entirety of the claims.

### BRIEF DESCRIPTION OF DRAWINGS

The drawings used to explain the embodiments show:

FIG. 1 shows steps in the manufacturing of a packaged electromagnetic coil assembly of an electrical component and an embodiment of a packaged electromagnetic coil assembly;

FIG. 2 shows steps in the manufacturing of a first choke and the first choke;

FIG. 3 shows steps in the manufacturing of a second choke and the second choke;

FIG. 4 shows steps in the manufacturing of a third choke and the third choke;

FIG. 5 shows steps in the manufacturing of a fourth choke and the fourth choke; and

FIG. 6 shows steps in the manufacturing of a fifth choke and the fifth choke.

In the figures, the same components are given the same reference symbols.

### DESCRIPTION OF EMBODIMENTS

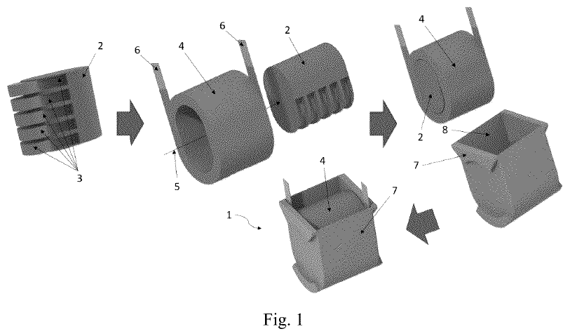

FIG. 1 shows steps in the manufacturing of an embodiment of a packaged electromagnetic coil assembly 1 of an electrical component. Five ferrite elements 3 are inserted into reception slots of a holder 2. The holder 2 is such that the ferrite elements 3 inserted into the reception slots are within the convex hull of the holder 2. Between neighbouring ferrite elements 3 in the holder 2, air gaps are formed. In the embodiment of a packaged electromagnetic coil assembly 1 as shown in FIG. 1, the air gaps are formed by the material of the holder, which material of the holder behaves magnetically similar to air.

After the ferrite elements 3 have been inserted into the holder 2, the holder 2 is inserted into an interior of a coil 4. The coil 4 is made of an enamelled wire and comprises two ends 6 through which it may be electrically contacted/connected. The coil 4 may be embodied as an edgewise-wound coil, for example. When a current flows through the coil 4, a magnetic field is created both in the interior of the coil as well as in the exterior, with all magnetic field lines being closed. The coil 4 comprises a magnetic axis 5 corresponding to a line of symmetry of the magnetic field pattern created by the coil when a current flows through it. In the symmetric embodiment of the coil 4 of FIG. 1, the magnetic axis 5 corresponds to a centre line through the interior of the coil 4. The magnetic axis 5 may be provided with a direction, the direction of the magnetic axis 5 for example corresponding to a direction of the magnetic field in the interior of the coil 4 when a current flows through the coil 4. The magnetic axis 5 need not be provided with a direction, however. The interior of the coil 4 is such that it substantially corresponds to the convex hull of the holder 2, so that the coil 4 tightly encloses the holder 2 after the holder 2 is inserted into the interior of the coil 4.

After the holder 2 has been inserted into the interior of the coil 4, thereby forming a coil assembly 2, 3, 4, the coil assembly 2, 3, 4 is inserted into an interior space surrounded by a cover 7 through an opening 8 in the cover 7. The coil 4 with holder 2 is potted in the interior space surrounded by cover 7 with a potting material. The coil 4 with holder 2 is inserted in such a way into the cover 7 that the ends 6 of the coil 4 pass through the opening 8, i.e. the ends 6 of the coil 4 are not surrounded by potting material.

In the embodiment of FIG. 1, the cover 7 is shaped in a substantially cup-like manner, i.e. the cover 7 comprises a bottom portion that is opposite to the opening 8 and lateral portions extending between the bottom portion and the opening 8. The interior space of the cover is the space contained between the opening, the lateral portion and the bottom portion, and the exterior space of the cover 7 is the space outside the cover. The cover 7 is matched in shape and volume to the coil assembly 2, 3, 4 so that, in an implementation, the coil assembly 2, 3, 4 is close to the inner sides of the cover 7, which inner sides face the interior space to facilitate cooling of the coil assembly 2, 3, 4.

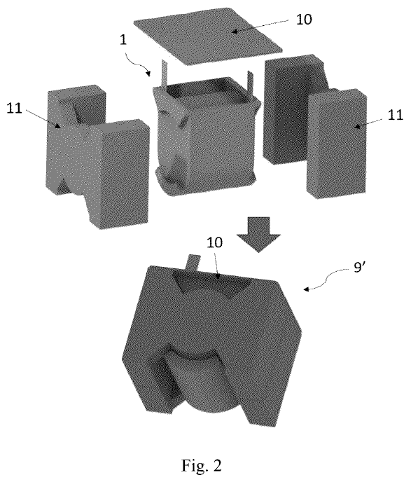

FIG. 2 shows steps in the manufacturing of a first choke 9′ and the first choke 9′. Around a packaged electromagnetic coil assembly 1, two ferrite core elements 11 are arranged. The two ferrite core elements 11 are identical: each comprises a circular section, two outer legs and two ‘V’ shaped sections between the circular section and the two outer legs. The cover 7 of the packaged electromagnetic coil assembly 1 is designed in such a way that on two opposite outer sides of the cover, the cover comprises a recess that is matched to a circular section of a ferrite core element 11, i.e. the circular section fits into the recess. After the circular section of a ferrite core element 11 is inserted into the recess, the outer legs of the ferrite core element 11 extend along the outer sides of the cover 7 that are parallel to the magnetic axis of the coil 4. The outer legs of the ferrite core elements 11 are in direct contact after assembly of the choke 9′. The ends 6 of the coil 4 are passed through slots in a baseplate 10, which baseplate also seals access to the interior space surrounded by the cover 7 through the opening 8 in the cover 7.

Each ferrite core element of the two ferrite core elements of FIG. 2 may also be termed two-leg one-flange ferrite U core element, the flange of the two-leg one-flange ferrite U core element being formed by the circular section and the two ‘V’ shaped sections. The soft-magnetic elements of the packaged electromagnetic coil assembly 1 form a centre leg, which together with the four outer legs of the two ferrite core elements 11 yield a three-leg EE core structure of the first choke 9′. Instead of an EE core structure, an EI core structure could also be employed to build the first choke, for example.

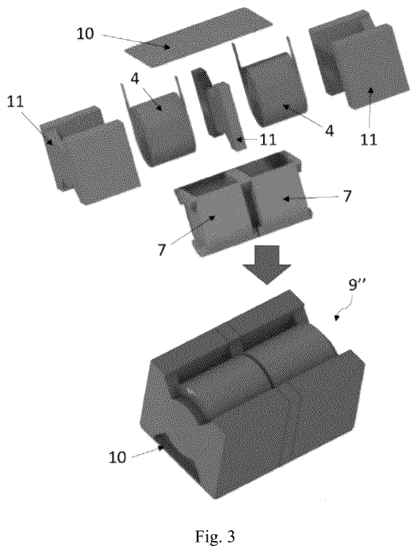

FIG. 3 shows steps in the manufacturing of a second choke 9″ and the second choke 9″. The second choke 9″ comprises two packaged electromagnetic coil assemblies, wherein each of the packaged electromagnetic coil assemblies may be manufactured as described above with respect to FIG. 1. The second choke 9″ further comprises three ferrite core elements 11. Two ferrite core elements of the three ferrite core elements 11 are embodied as two-leg one-flange U core elements, and a third ferrite core element of the three ferrite core elements 11 is embodied as an I plate core element.

The two covers 7 of the two packaged electromagnetic coil assemblies of FIG. 3 are connected to each other. The I plate core element is inserted into a space between the two covers 7. The four ends of the two packaged electromagnetic coil assemblies are guided through four slots in a baseplate 10.

The second choke 9″ is built using an EIE core structure. The soft-magnetic elements of the packaged electromagnetic coil assemblies provide the centre legs. Instead of an EIE core structure, an EEE core structure or other similarly modified core structures could be used as well.

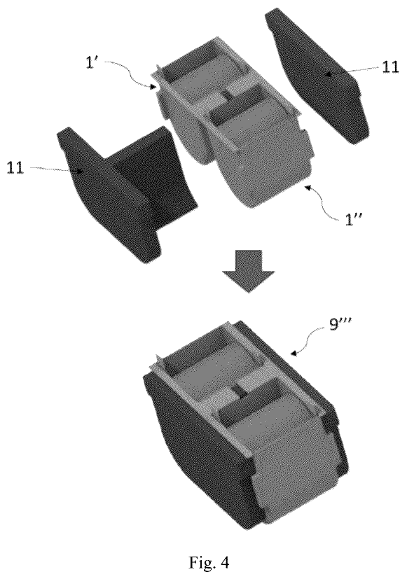

FIG. 4 shows steps in the manufacturing of a third choke 9′″ and the third choke 9′″. The third choke 9′” comprises two ferrite core elements 11 and two packaged electromagnetic coil assemblies 1′, 1″ arranged next to one another, their magnetic axes being distinct and parallel to each other. Between the covers of the two packaged electromagnetic coil assemblies 1′, 1″, a space is provided into which a protruding ferrite core section of a first ferrite core element of the two ferrite core elements 11 is inserted. The first ferrite core element is therefore embodied as a ferrite core element with one leg, namely the protruding ferrite core section, and two flanges.

A second ferrite core element of the two ferrite core elements 11 is embodied as an I plate core element. In the embodiment of FIG. 4, the space between the two packaged electromagnetic coil assemblies 1′, 1″ increases when moving away from the opening sides of the two packaged electromagnetic coil assemblies 1′, 1″: the protruding ferrite core section is matched to this increasing space between the two packaged electromagnetic coil assemblies so that it fills out the space between the two packaged electromagnetic coil assemblies.

The third choke 9″″′ is built using an EI core structure. The soft-magnetic elements of the packaged electromagnetic coil assemblies 1′, 1″ form outer legs. Alternatively, an EE core structure could be employed as well, for example, wherein two identical one-leg two-flange ferrite core elements could be used.

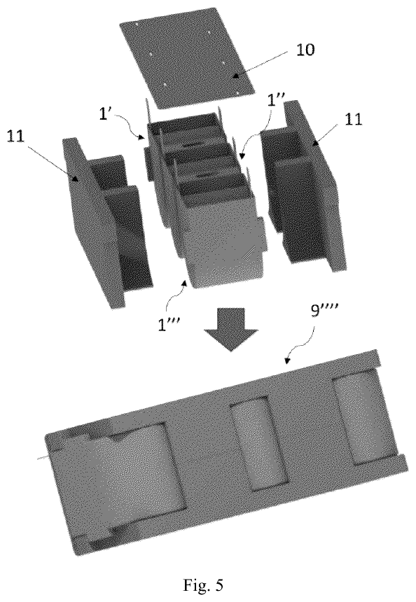

FIG. 5 shows steps in the manufacturing of a fourth choke 9″” and the fourth choke 9″″. The fourth choke 9“ ” comprises three packaged electromagnetic coil assemblies 1′, 1″, 1″″, whose magnetic axes are distinct and parallel to each other. Between two neighbouring packaged electromagnetic coil assemblies, a respective space is provided, which respective space grows with increasing distance from the opening sides of the packaged electromagnetic coil assemblies l′, 1″, 1″.

The fourth choke 9″” comprises two identical ferrite core elements 11, namely two two-leg three-flange ferrite core elements. Each ferrite core element 11 comprises two protruding ferrite core sections which are matched to the two spaces between neighbouring packaged electromagnetic coil assemblies 1′, 1″, 1″: the two protruding ferrite core sections of each ferrite core element thereby fill out half of the space between the packaged electromagnetic coil assemblies after assembly of the fourth choke 9″” and are in direct contact with the two protruding ferrite core section of the other ferrite core element.

The fourth choke 9″ is built using a WW core structure. The soft-magnetic elements of the packaged electromagnetic coil assemblies 1′, 1″, 1″″′ form centre legs and outer legs completed with the two identical two-leg three-flange ferrite core elements 11. Alternatively, a WI core structure could be employed as well to build the fourth choke, for example, with one two-leg three-flange ferrite core element and one I plate core element being used.

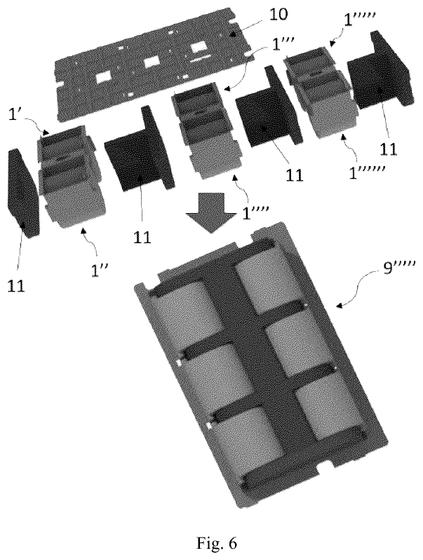

FIG. 6 shows steps in the manufacturing of a fifth choke 9″″″ and the fifth choke 9″″″″. The fifth choke 9″″″ comprises six packaged electromagnetic coil assemblies 1′-1″″″, four ferrite core elements 11 and a baseplate 10. The ferrite core elements 11 of FIG. 6 are designed similarly to the ferrite core elements as described above with reference to FIG. 4, i.e. three of the four ferrite core elements 11 fill out the spaces between the first 1′ and the fourth 1″, the second 1′″ and the fifth 1″″, and the third 1″″″″ and the sixth 1″″″ packaged electromagnetic coil assemblies, respectively.

The fifth choke 9″″“ ” is built using an EEEI core structure. The soft-magnetic elements of the packaged electromagnetic coil assemblies 1′-1″″“ ” form outer legs. Alternatively, an EIEE or EEEE core structure could be used as well to build the fifth choke, for example.

What is claimed is:

1. Electrical component, comprising (i) at least one soft-magnetic core element and (ii) at least one packaged electromagnetic coil assembly, with each packaged electromagnetic coil assembly of the at least one packaged electromagnetic coil assembly comprising
a. at least one soft-magnetic element,
b. a thermally conductive and electrically insulating holder, wherein the at least one soft-magnetic element is within the convex hull of the holder and held by the holder, and wherein the holder is made of a first diamagnetic material or a first paramagnetic material,
c. a coil formed of enamelled wire and having a magnetic axis and two ends, wherein the wire of the coil is wound around the holder with the at least one soft-magnetic element, with the coil, the holder and the at least one soft-magnetic element forming a coil assembly, wherein the holder and the coil are such that the magnetic axis of the coil passes through at least one air gap provided by the holder, and
d. a thermally conductive and electrically insulating cover, which cover comprises an inner side facing an interior space surrounded by the cover and an outer side facing an exterior space, which interior space is only accessible through one opening in the cover and with the coil assembly being arranged in the interior space, wherein the cover and the coil assembly are such that only the two ends of the wire of the coil protrude through the opening, wherein the cover is made of a second diamagnetic material or a second paramagnetic material, and wherein the packaged electromagnetic coil assembly comprises a thermally conductive and electrically insulating potting material, with the coil assembly being potted in the interior space surrounded by the cover with the potting material,
wherein each soft-magnetic core element of the at least one soft-magnetic core element is in direct contact with at least a part of the outer side of the cover of one or more of the at least one packaged electromagnetic coil assembly, and wherein each soft-magnetic core element of the at least one soft-magnetic core element is at most in contact with the potting material of the at least one packaged electromagnetic coil assembly at surfaces of the respective soft-magnetic core element facing the outer side of the cover of the one or more of the at least one packaged electromagnetic coil assembly with which the respective soft-magnetic core element is in direct contact.

2. Electrical component according to claim 1, wherein the coil of at least one of the at least one packaged electromagnetic coil assembly is an edgewise-wound coil.

3. Electrical component according to claim 1, wherein for at least one of the at least one packaged electromagnetic coil assembly, the coil assembly and the potting material together fill up the interior space surrounded by the cover, and/or wherein for at least one of the at least one packaged electromagnetic coil assembly, the coil assembly and the cover are embodied such that a shape and volume of the interior space is substantially matched to a shape and volume of the coil assembly, and/or wherein for at least one of the at least one packaged electromagnetic coil assembly, the cover is shaped in a substantially cup-like manner, with the substantially cup-like cover being such that both the coil assembly and the potting material are inserted through the opening into the interior space surrounded by the cover, and/or wherein for at least one of the at least one packaged electromagnetic coil assembly, the cover is embodied as a one-piece cover.

4. Electrical component according to claim 1, wherein the holder comprises at least two reception slots, with a soft-magnetic element being inserted into each of the at least two reception slots, and wherein the at least two reception slots and the shape of the at least two inserted soft-magnetic elements are such that an air gap is present between any two inserted soft-magnetic elements.

5. Electrical component according to claim 1, further comprising a baseplate with slots, wherein the ends of the coil of each of the at least one packaged electromagnetic coil assembly are guided through the slots, and wherein the baseplate is embodied and positioned such at the opening of each of the at least one packaged electromagnetic coil assembly that it prevents access to the interior space of the respective packaged electromagnetic coil assembly from the exterior space of the respective packaged electromagnetic coil assembly.

6. Electrical component according to claim 1, wherein the electrical component is embodied as a choke.

7. Electrical component according to claim 6, comprising one packaged electromagnetic coil assembly and two soft-magnetic core elements, wherein the two soft-magnetic core elements are in direct contact with each other and provide a closed loop path around the packaged electromagnetic coil assembly.

8. Electrical component according to claim 6, comprising a) two packaged electromagnetic coil assemblies whose respective magnetic axes are distinct and parallel to each other, with the two packaged electromagnetic coil assemblies being arranged next to one another, and b) two soft-magnetic core elements, wherein the two soft-magnetic core elements are, with respect to the two parallel magnetic axes, arranged on opposite sides of the two packaged electromagnetic coil assemblies, wherein a first soft-magnetic core element of the two soft-magnetic core elements comprises a protruding soft-magnetic core section extending into a space between the two packaged electromagnetic coil assemblies, and wherein a second soft-magnetic core element of the two soft-magnetic core elements is directly connected to the protruding soft-magnetic core section.

9. Electrical component according to claim 6, comprising a) two packaged electromagnetic coil assemblies whose respective magnetic axes extend along a common line and b) three soft-magnetic core elements, wherein two soft-magnetic core elements of the three soft-magnetic core elements are arranged on opposite sides of the two packaged electromagnetic coil assemblies with respect to the common line, and wherein a third of the three soft-magnetic core elements is arranged between the two packaged electromagnetic coil assemblies, wherein each of the two soft-magnetic core elements is in direct contact with the third soft-magnetic core element.

10. Electrical component according to claim 6, comprising a) three packaged electromagnetic coil assemblies whose respective magnetic axes are distinct and parallel to each other, with the three packaged electromagnetic coil assemblies being arranged next to one another, and b) two soft-magnetic core elements, wherein the two soft-magnetic core elements are, with respect to the three parallel magnetic axes, arranged on opposite sides of the three packaged electromagnetic coil assemblies, wherein each of the two soft-magnetic core elements comprises respective protruding soft-magnetic core sections extending into a first space and a second space, with the first space being between a first and a second packaged electromagnetic coil assembly of the three packaged electromagnetic coil assemblies and with the second space being between the second and a third packaged electromagnetic coil assembly of the three packaged electromagnetic coil assemblies, and wherein the first soft-magnetic core element is directly connected to the second soft-magnetic core element via their respective protruding soft-magnetic core sections in both the first space and the second space.

11. Electrical component according to claim 6, comprising
a) six packaged electromagnetic coil assemblies, wherein a first, second and third packaged electromagnetic coil assembly have magnetic axes extending along a first common line and wherein a fourth, fifth and sixth packaged electromagnetic coil assembly have magnetic axes extending along a second common line, wherein the first common line and the second common line are distinct and parallel to each other, wherein the first packaged electromagnetic coil assembly is arranged next to the fourth packaged electromagnetic coil assembly, wherein the second packaged electromagnetic coil assembly is arranged next to the fifth packaged electromagnetic coil assembly, and wherein the third packaged electromagnetic coil assembly is arranged next to the sixth packaged electromagnetic coil assembly, and
b) four soft-magnetic core elements, wherein
a. a first soft-magnetic core element of the four soft-magnetic core elements is in direct contact with the first and the fourth packaged electromagnetic coil assemblies,
b. a second soft-magnetic core element of the four soft-magnetic core elements is in direct contact with (i) the second and the fifth packaged electromagnetic coil assemblies and with (ii), via a second protruding soft-magnetic core section of the second soft-magnetic core element protruding into a first space between the first and the fourth packaged electromagnetic coil assemblies, the first and the fourth packaged electromagnetic coil assemblies,
c. a third soft-magnetic core element of the four soft-magnetic core elements is in direct contact with (i) the third and the sixth packaged electromagnetic coil assemblies and with (ii), via a third protruding soft-magnetic core section of the third soft-magnetic core element protruding into a second space between the second and the fifth packaged electromagnetic coil assemblies, the second and the fifth packaged electromagnetic coil assemblies, and
d. a fourth soft-magnetic core element of the four soft-magnetic core elements is in direct contact with the third and the sixth packaged electromagnetic coil assemblies, wherein the fourth soft-magnetic core element comprises a fourth protruding soft-magnetic core section protruding into a third space between the third and the sixth electromagnetic coil assemblies.

12. Method for manufacturing an electrical component according to claim 1, comprising the following steps:
a) For each packaged electromagnetic coil assembly of the at least one packaged electromagnetic coil assembly
i) Providing the thermally conductive and electrically insulating holder with the at least one soft-magnetic element;
ii) Forming the coil assembly by placing the coil around the holder;
iii) Inserting, through the opening in the cover, the coil assembly into the interior space surrounded by the cover and the thermally conductive and electrically insulating potting material; and
b) Arranging the at least one soft-magnetic core element such that it is in direct contact with at least a part of the outer side of the cover of one or more of the at least one packaged electromagnetic coil assembly and such that each soft-magnetic core element of the at least one soft-magnetic core element is at most in contact with the potting material of the at least one packaged electromagnetic coil assembly at surfaces of the respective soft-magnetic core element facing the outer side of the cover of the one or more of the at least one packaged electromagnetic coil assembly with which the respective soft-magnetic core element is in direct contact.

13. Method according to claim 12, wherein for at least one of the at least one packaged electromagnetic coil assembly, the coil is embodied as an edgewise-wound coil surrounding an empty interior and wherein the two ends of the edgewise-wound coil are directed into a same direction and are on an ending side of the coil, wherein the step of placing the coil around the holder comprises inserting the holder into the empty interior of the edgewise-wound coil and wherein in the step of inserting of the coil assembly into the interior space surrounded by the cover, the coil assembly is inserted in such a way into the interior space that the side of the coil opposite to the ending side is inserted first into the interior space and the two ends of the coil protrude out of the cover through the opening in the cover after the coil assembly is inserted into the interior space.

14. Method according to claim 12, further comprising the following steps:
c) Guiding the ends of the coil of each of the at least one packaged electromagnetic coil assembly through slots of a baseplate.

15. Vehicle comprising an on-board charger with a chassis surrounding a cavity for receiving an electrical component, wherein an electrical component according to claim 1 is placed into the cavity.

16. Vehicle according to claim 15, wherein the electrical component is potted into the cavity with a thermally conductive chassis potting material.
